(19) United States
(12) Patent Application Publication
(10) Pub. No.: US 2011/0109059 A1
(43) Pub. Date: May 12, 2011

(54) FOLDING BICYCLE

(76) Inventor: Robert Loane Dumaresq, Armadale (AU)

(21) Appl. No.: 12/616,381

(22) Filed: Nov. 11, 2009

(51) Int. Cl. B62K 15/00

(52) U.S. Cl. 280/278

(57) ABSTRACT

A folding bicycle being foldable between an erect condition for riding and a compact folded condition, including a main frame, a rear frame coupling a rear wheel of the bicycle to the main frame, and a front arm coupling a front wheel of the bicycle to the main frame, wherein in folding the bicycle from the erect condition to the folded condition the rear frame is folded relative to the main frame about a pivot axis substantially transverse to the bicycle to overlap the front and rear wheels.

### FIELD OF THE INVENTION

This invention relates to a folding bicycle and, more particularly but not exclusively, to a folding bicycle which is suitable for use in commuting on public transport and/or for providing transportation in areas with high density living.

### BACKGROUND OF THE INVENTION

Folding bicycles in general are well known. In fact, folding bicycles are quite commonly used where a bicycle is to be carried in the boot of a car, stored in a small apartment, or transported overseas in a suitcase. However, existing designs of folding bicycles are developed on the notion that the bicycle must be as small as possible when in a folded configuration. For example, one particular form of existing folding bicycle folds up sufficiently small so as to be carried in a small bag on the back of a user when not being ridden. Another form of existing folding bicycle folds into a suitcase configuration when not being ridden. However, these existing folding bicycles are not suitable for being ridden for longer distances, and do not handle well because of the small wheels used. Moreover, folding bicycles of these types may also have a restrictive rider weight limit due to the lightweight construction, and may be difficult to fold.

There are also existing folding bicycles which are quick to fold, and have larger wheels, however such types of existing folding bicycles are typically bulky when folded and are heavy. Other existing folding bicycles with larger wheels may have the wheels removed from the frame of the bicycle when put into the folded condition, adding to the time required to fold the bicycle and potential difficulty in transporting the bicycle when folded.

The applicant has determined that it would be beneficial for there to be provided a folding bicycle which is suitable for commuting on public transport, which is conveniently foldable, which is sufficiently small so as to be conveniently transportable on public transport, and which is suitable for riding longer distances (e.g. to and from public transport and/or a place of employment).

Examples of the invention seek to solve, or at least ameliorate, one or more disadvantages of previous folding bicycles.

### SUMMARY OF THE INVENTION

In accordance with one aspect of the present invention, there is provided a folding bicycle being foldable between an erect condition for riding and a compact folded condition, including a main frame, a rear frame coupling a rear wheel of the bicycle to the main frame, and a front arm coupling a front wheel of the bicycle to the main frame, wherein in folding the bicycle from the erect condition to the folded condition the rear frame is folded relative to the main frame about a pivot axis substantially transverse to the bicycle to overlap the front and rear wheels.

Preferably, when in the folded condition the front and rear wheels are adjacent. More preferably, when in the folded condition a hub of the front wheel is adjacent a hub of the rear wheel. Even more preferably, the front and rear hubs are single sided hubs and in the folded condition a free end of the front wheel hub is adjacent a free end of the rear wheel hub.

Preferably, a disc of a front disc brake is mounted to the front wheel and a disc brake calliper of the front disc brake is mounted to the front arm. Similarly, in a preferred form, a disc of a rear disc brake is mounted to the rear wheel and a disc brake calliper of the rear disc brake is mounted to the rear frame.

Preferably, the bicycle is arranged such that when in the erect condition weight of a rider on a saddle of the bicycle biases the rear frame toward the erect condition. More preferably, the rear frame forms a triangle and one side of the triangle abuts a rear face of the main frame when in the erect condition. In a preferred form, when in the erect condition, a member of the rear frame is seated within a sleeve of the main frame.

Preferably, the pivot axis is substantially in line with an axis about which a drive crank rotates.

In a preferred form, the rear frame pivots about a bottom bracket of the bicycle.

Preferably, the pivot axis is angled relative to a transverse direction of the bicycle such that the rear wheel lies within a central longitudinal plane of the bicycle in the erect condition and the rear wheel lies outside and substantially parallel to the central longitudinal plane when in the folded condition. More preferably, the pivot axis is angled at between 1 and 5 degrees relative to the transverse direction of the bicycle. Even more preferably, the pivot axis is angled at between 1.5 and 2.5 degrees relative to the transverse direction of the bicycle.

Preferably, in folding the bicycle from the erect condition to the folded condition the front wheel is pivoted relative to the main frame about a steering axis to a reversed configuration. More preferably, the front arm comprises a pivot body, a down member, and an extension portion between the pivot body and the down member, in the erect condition the extension portion positions the down member forward of the steering axis and in the folded condition the extension portion positions the down member rearward of the steering axis.

Preferably, the pivot body comprises a bearing housing.

In a preferred form, in the reversed configuration the extension portion is housed within a recess formed in a side of the main frame, and the down member extends outwardly and downward from the recess.

Preferably, in folding the bicycle from the erect condition to the folded condition the front arm and rear frame are folded simultaneously relative to the main frame.

In a preferred form, the front arm has a handlebar fixed thereto for steering the bicycle, the handlebar including a central portion and a handle portion at each end pivotally attached to the central portion at pivot locations, wherein each handle portion is locked in line with the central portion by way of a respective locking ring which is biased to a locked condition over the pivot locations, and the handle portions are able to be folded relative to the central portion by sliding the locking rings away from the pivot locations.

Preferably, the front and rear wheels are 26 or 27 inches in diameter. More preferably, the front and rear wheels are of size 700C.

### BRIEF DESCRIPTION OF THE DRAWINGS

The invention is described, by way of non-limiting example only, with reference to the accompanying drawings in which:

FIG. 1 shows a left-hand side view of a folding bicycle in accordance with an example of the present invention;

FIG. 2 shows a right-hand side view of the folding bicycle in a partially folded condition;

FIG. 3 shows a right-hand side view of the folded bicycle in a further partially folded condition;

FIG. 4 shows a right-hand side view of the folding bicycle in a further partially folded condition;

FIG. 5a shows a right-hand side view of the folded bicycle in a folded condition;

FIG. 5b shows a folded bicycle of an alternative example in a folded condition and in a vertical orientation;

FIG. 6a shows a top perspective view, of a handlebar of the bicycle in an erect condition;

FIG. 6b shows a perspective top view of the handlebar in a partially folded condition;

FIG. 6c shows a perspective top view of the handlebar in a folded condition;

FIG. 7 shows parts of the folded bicycle in a disassembled state;

FIG. 8 shows a diagrammatic view of a set of main components of the folded bicycle in a disassembled state;

FIG. 9a is a diagrammatic sketch of a folded bicycle in accordance with an example of the present invention, shown in an erect condition; and

FIG. 9b shows the folded bicycle of FIG. 9a in a folded condition.

### DETAILED DESCRIPTION

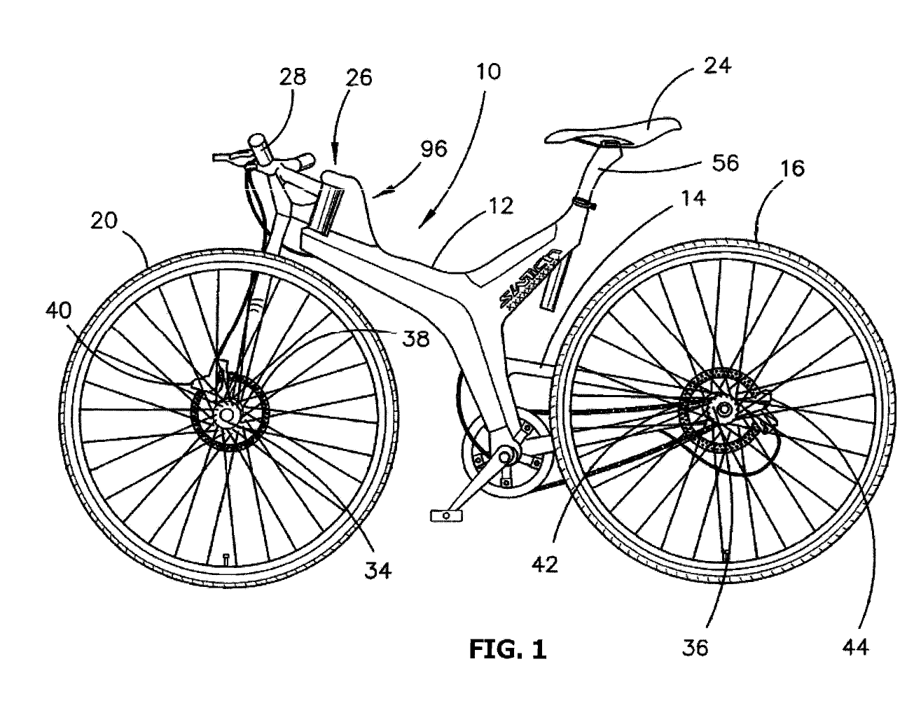

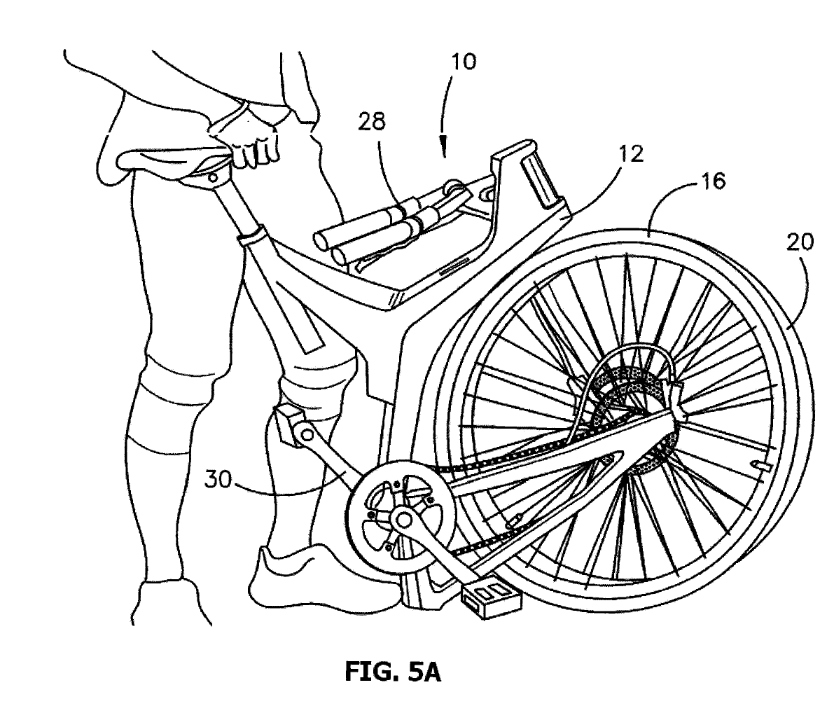

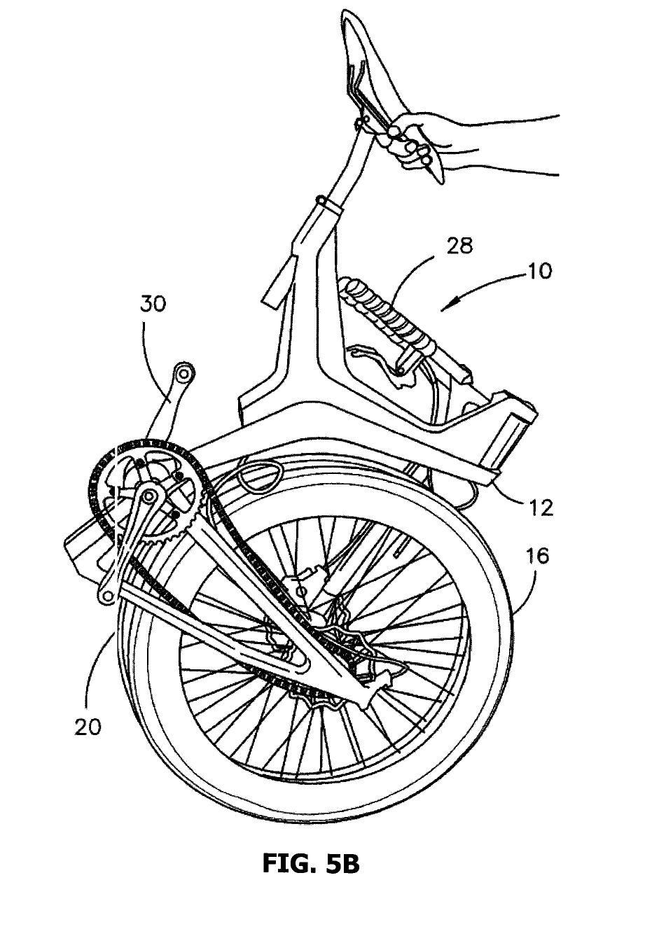

With reference to FIGS. 1 to 9b, there is shown a folding bicycle 10 which is able to be conveniently folded between an erect condition (see FIG. 1) and a folded condition (see FIG. 5a). Accordingly, the bicycle 10 is able to be used for commuting, as it is suitable for riding relatively long distances to and from public transport, and is also suitable for being quickly folded/unfolded at each end, as well as being sufficiently small to consume a minimum amount of space on-board public transport, for example when held up against the body of the user.

The compact nature of the bicycle when folded is achieved by virtue of the bicycle 10 folding with its wheels substantially completely overlapping, and with extremities of the bicycle lying substantially within a footprint of the overlapping wheels. In particular examples of the invention, the extremities of the bicycle 10 in the folded condition may be entirely within opposite parallel planes which are tangential to the wheels of the bicycle. Accordingly, the bicycle can be held up against the body of the user, resting the wheels on the ground and with the frame of the bicycle above the wheels.

More specifically, the folding bicycle 10 includes a main frame 12, a rear frame 14 coupling a rear wheel 16 of the bicycle 10 to the main frame 12, and a front arm 18 coupling a front wheel 20 of the bicycle 10 to the main frame 12. In folding the bicycle 10 from the erect condition to the folded condition, the rear frame 14 is folded relative to the main frame 12 about a pivot axis 22, which is substantially transverse to the bicycle 10, to overlap the front and rear wheels 16, 20.

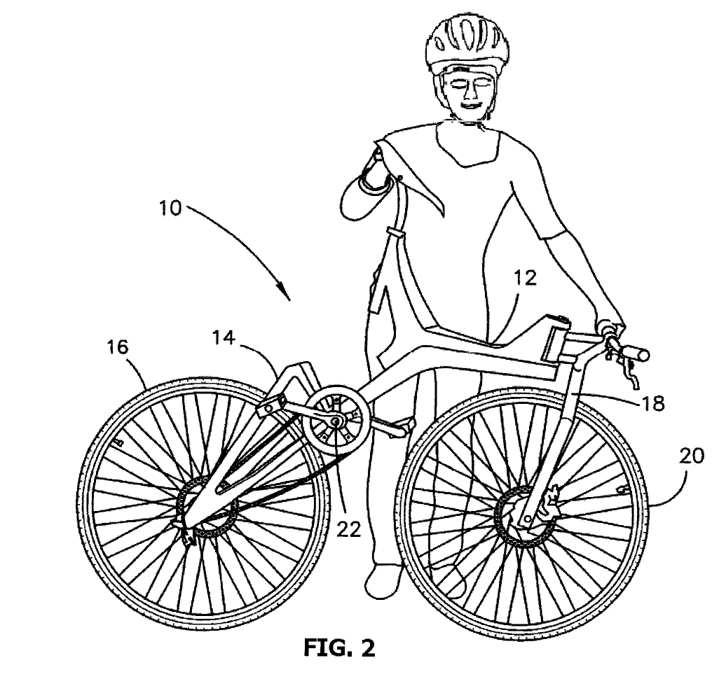

FIG. 1 shows the folding bicycle 10 in the erect condition for riding. FIG. 5a shows the folding bicycle 10 in the compact folded condition suitable for carrying on public transport and FIGS. 2 to 4 show progressive states of the folding bicycle 10 between the erect condition and the folded condition.

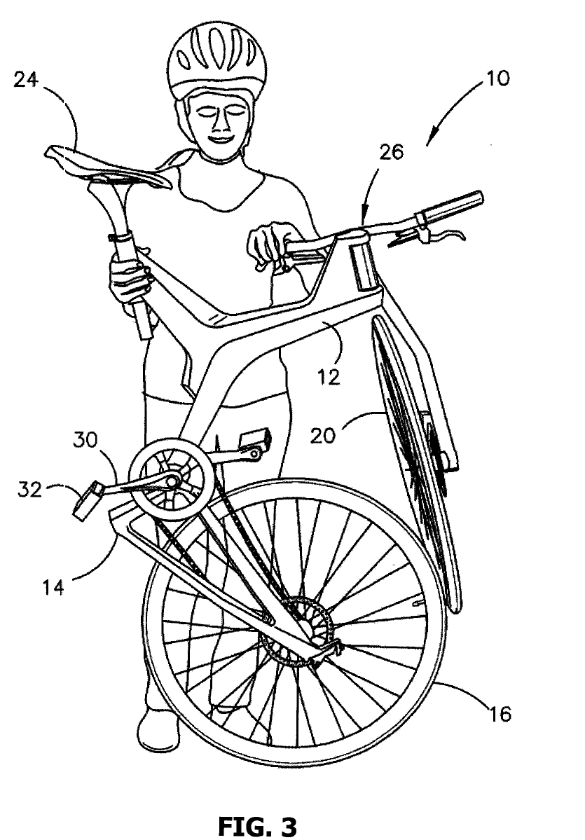

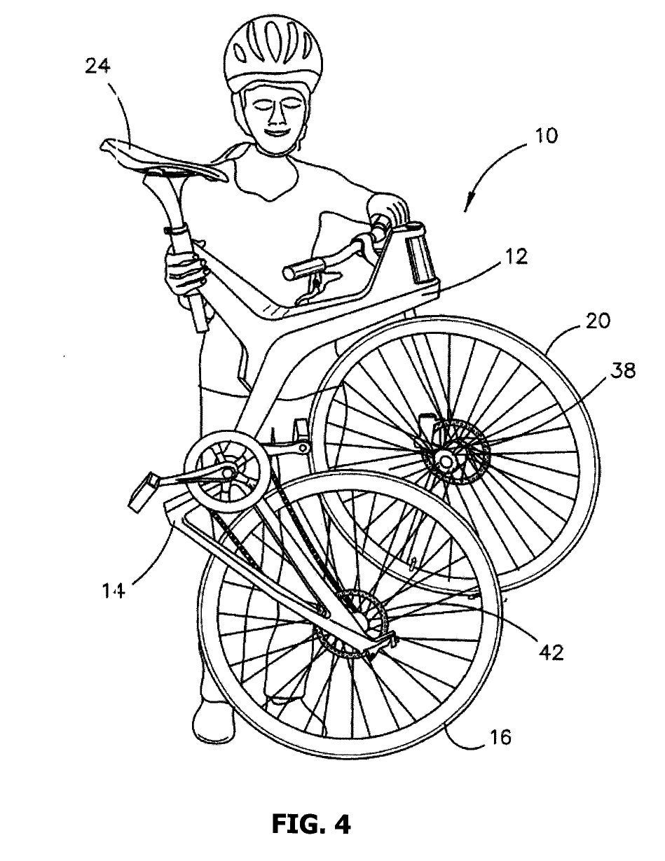

The folding bicycle 10 is brought from the erect condition to the folded condition by lifting up the saddle 24 to allow the rear frame 14 to pivot about the pivot axis 22 relative to the main frame 12, while simultaneously pivoting the front arm 18 relative to the main frame 12. FIG. 2 shows the saddle 24 being lifted so as to allow the rear frame 14 to pivot about the pivot axis 22 relative to the main frame 12, prior to pivoting of the front arm 18 about a steering axis 26. FIG. 3 shows the saddle 24 raised further so as to allow further rotation of the rear frame 14 about the pivot axis 22, with the front wheel 20 pivoted approximately midway between a forward configuration for riding and a reversed configuration. FIG. 4 shows the front wheel 20 being brought to the reversed configuration relative to the main frame 12. In FIG. 5a, the rear wheel 16 is pivoted so as to substantially coincide with the front wheel 20, with a handlebar 28 in a folded configuration.

Advantageously, the folding bicycle 10 is able to be brought very quickly between the erect condition and the folded condition to facilitate use of the folding bicycle 10 when used during regular commuting, so that the bicycle 10 can be ridden (potentially long distances) to public transport, transported on the public transport in the folded condition, then brought to the erect condition for riding (potentially long distances) from the public transport to the destination. As the front and rear wheels 20, 16 are brought to lie substantially directly one on top of the other when in the folded condition, the folding bicycle 10 is virtually no wider than the width of the two wheels 16, 20, and can be held upright against the user so as to take up a minimum of space on crowded public transport (e.g. trains, buses, trams, ferries, etc.). It is also advantageous that the folding bicycle 10 uses large 26 or 27 inch (700C) wheels, similar to those used on common racing bicycles, to facilitate stability and to enable a rider to travel longer distances if necessary. Furthermore, when in the erect condition as shown in FIG. 1, the weight of the rider on the saddle 24 biases the rear frame 14 against the mainframe 12 in the erect condition such that no additional locking mechanism is required, contributing to a minimal time for conversion between the erect and folded conditions. The bicycle 10 may nevertheless be provided with a non-structural locking mechanism to prevent the bicycle from unfolding inadvertently (e.g. when weight is removed from the saddle, or if the wheels of the bicycle leave the ground during riding). The locking mechanism may be non-structural in that structurally it is not required to hold the bicycle together in the erect condition during normal riding of the bicycle, and may take various different forms (e.g. a spring-loaded ball-bearing or a locking pin).

As the wheels 16, 20 are brought to overlap when the folding bicycle 10 is in the folded condition, the wheels 16, 20 are able to rotate together so that the folding bicycle 10 can be wheeled using the saddle 24 as a handle, as shown in FIG. 5a. Where a freewheeling rear hub is used, the folding bicycle 10 is able to be wheeled in a direction away from the user shown in FIG. 5a without rotation of the crank 30 and pedals 32. The pedals 32 may be folding pedals so as to minimise the thickness of the folding bicycle 10 when in the folded condition.

More specifically, when in the folded condition, the front wheel 20 is adjacent the rear wheel 16, with a hub 34 of the front wheel 20 being adjacent a hub 36 of the rear wheel 16. The front and rear hubs 34, 36 may be single sided hubs such that, in the folded condition, a free end of the front wheel hub 34 is adjacent a free end of the rear wheel hub 36. The single sided hubs may be of a similar kind to those used in typical wheelchairs, and allow for the wheels 16, 20 to be brought closer together so as to minimise the thickness of the folding bicycle 10 when in the folded condition.

Accordingly, where the front and rear hubs 34, 36 are single sided hubs, the rear frame 14 and front arm 18 support the respective wheels 16, 20 from only one side, enhancing the ability of the folding bicycle 10 to fold into a compact configuration and also providing an attractive visual aspect to the folding bicycle 10. On the single sided supports there are mounted disc brakes for braking the front and rear wheels 20, 16. More specifically, a disc 38 of a front disc brake is mounted to the front wheel 20, and a disc brake calliper 40 of the front disc brake is mounted to the front arm 18. Similarly, a disc 42 of the rear disc brake is mounted to the rear wheel 16 and a disc brake calliper 44 of the rear disc brake is mounted to the rear frame 14. In alternative examples, the bicycle may have other types of brakes other than disc brakes.

FIG. 5b shows a folding bicycle 10 in accordance with a similar example of the present invention, in the folded condition and in a vertical orientation suitable for a crowded environment, e.g., on a train or in an elevator. The bicycle frame 12 stands in the vertical space above the footprint of the wheels 16, 20 taking up a small space, minimising intrusion on other people within the environment. As the wheels 16, 20 are generally parallel in the folded condition, the wheels 16, 20 are able to be rolled on the ground with the seat being used to push the bicycle 10.

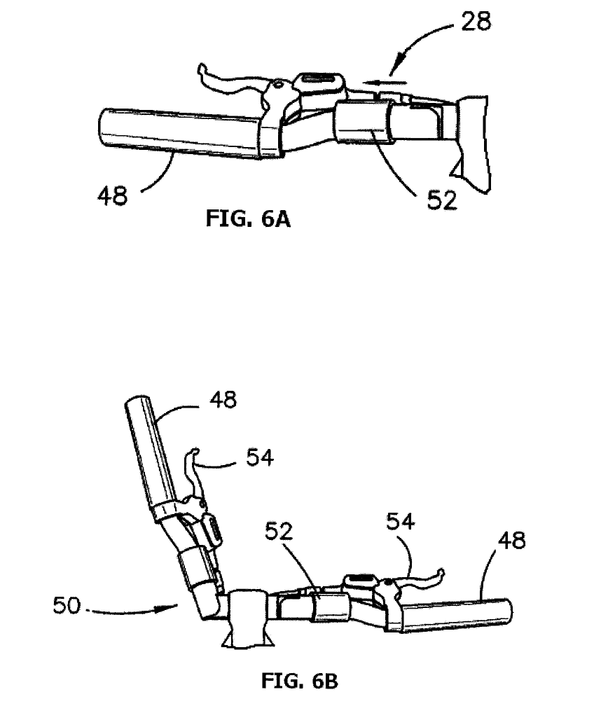

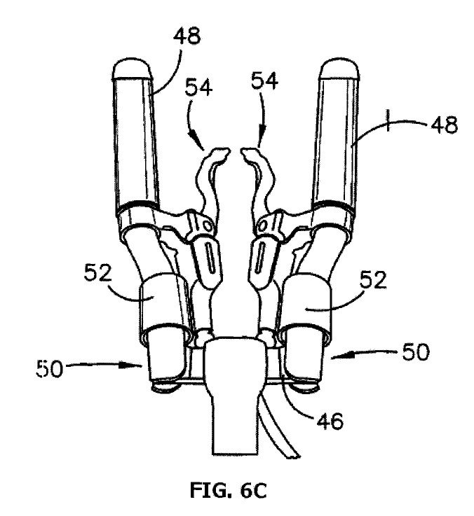

With reference to FIGS. 6a to 6c, the handlebar 28 is fixed to the front arm 18 for steering the bicycle 10. The handlebar 28 includes a central portion 46 and a handle portion 48 at each end, pivotally attached to the central portion 46 at pivot locations 50. Each handle portion 48 is locked in line with the central portion 46 by way of a respective locking ring 52 which is biased to a locked condition over the respective pivot locations 50, and the handle portions 48 are able to be folded relative to the central portion 46 by sliding the locking rings 52 away from the pivot locations 50. The user may choose to fold the handlebar 28 in this way when the folding bicycle 10 is brought to the folded condition, or may choose in some instances (particularly where the folding bicycle 10 is to remain in the folded condition only for a brief period) to allow the handlebar 28 to remain in its unfolded condition. The handlebar 28 may be removed from the front arm 18, and the user may their own choice of alternative handlebar. This is achievable by virtue of the neck of the front arm 18 having a standard sized aperture for clamping the handlebar 28. The brake levers 54 may use either a hydraulic or cable connection for actuating the disc brakes.

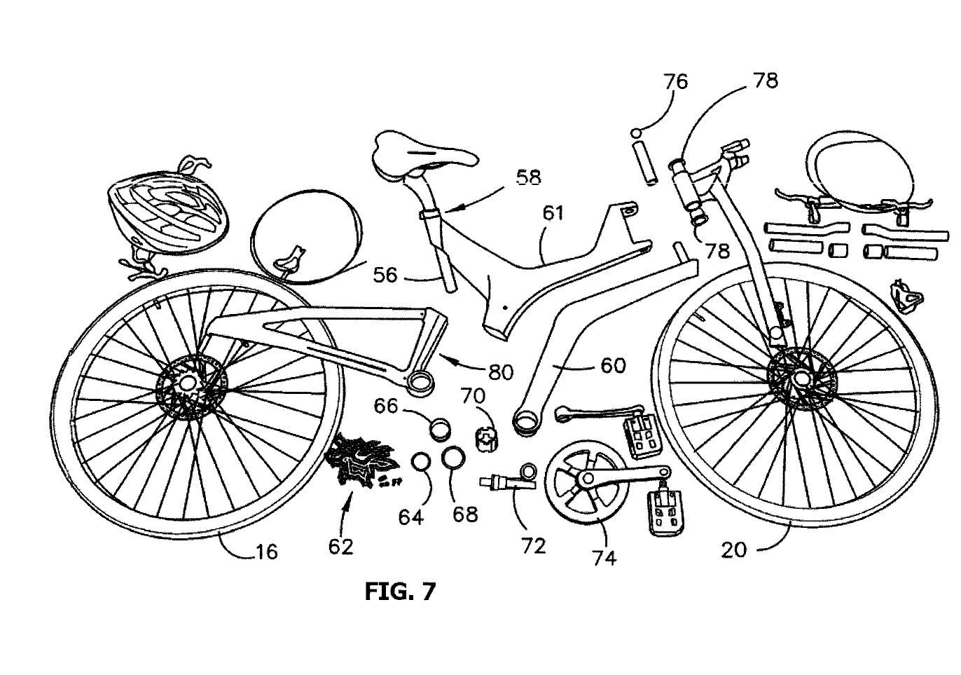

In addition to the parts already described, FIG. 7 shows a disassembled view of the folding bicycle 10, showing the following additional parts: seat post 56, seat clamp 58, aluminium main frame component 60, carbon fibre main frame component 61, drive chain 62, left-hand bottom bracket washer 64, bottom bracket offset bush 66, right-hand bottom bracket washer 68, bottom bracket 70, sealed axle cartridge 72, chain wheel 74, steering cap 76 and nylon bearing 78.

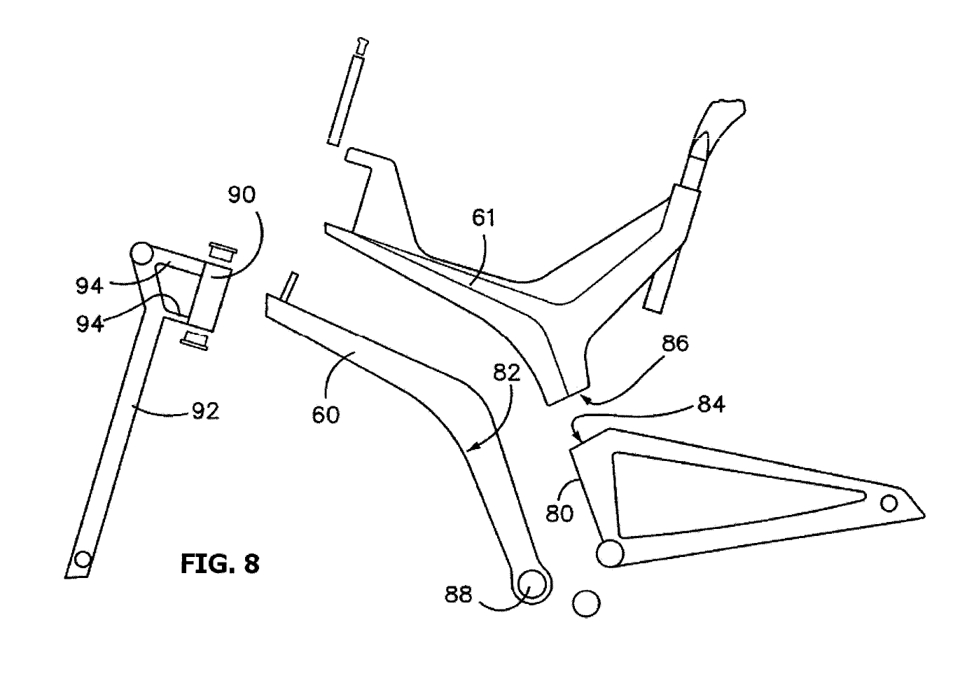

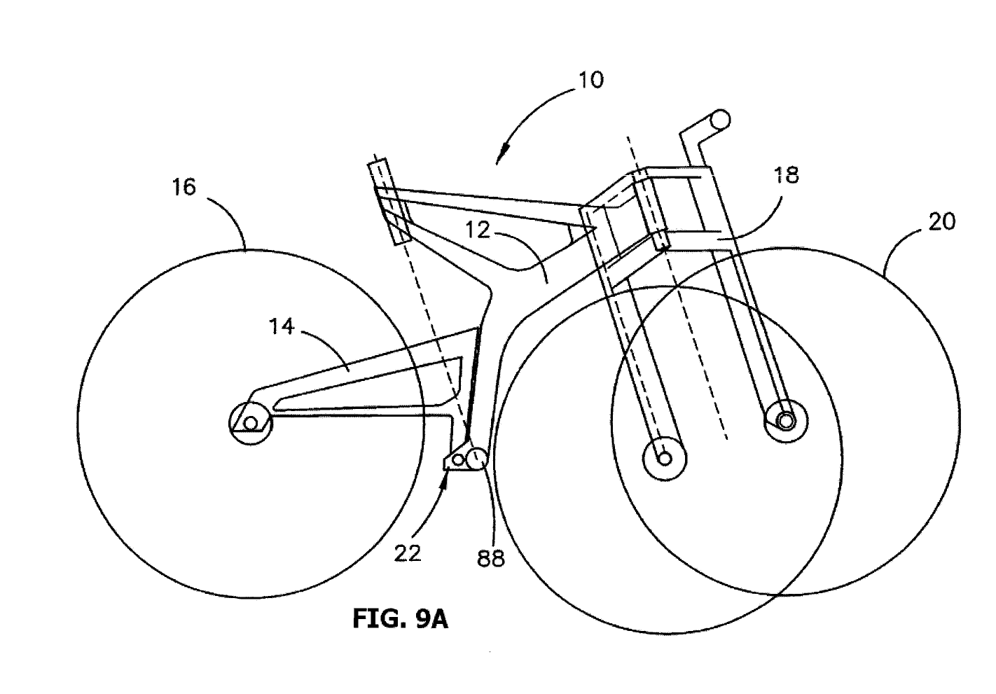

With reference to FIG. 8 the aluminium main frame component 60, carbon fibre main frame component 61 and rear frame 14 are configured such that when in the erect condition, weight of the rider on the saddle 24 biases the rear frame 14 toward the erect condition. More specifically, the rear frame 14 forms a triangle and one side 80 of the triangle abuts a rear face 82 of the aluminium main frame component 60 when in the erect condition. The aluminium main frame component 60 is channelled into a sleeve such that, when in the erect condition, a member of the rear frame 14 at said one side 80 is seated within the sleeve of the aluminium main frame component 60 to provide lateral strength to the bicycle 10 when ridden. Furthermore, an upper face 84 of the rear frame 14 abuts against a bottom face 86 of the carbon fibre main frame component 61 when in the erect condition.

In the example shown in FIGS. 1 to 8, the pivot axis 22 is substantially in line with an axis 88 about which the drive crank 30 rotates. This is achieved by way of the rear frame 14 being arranged to pivot about the bottom bracket 70 of the bicycle 10. To enable the rear wheel 16 to swing next to the front wheel 20 when in the folded condition, the pivot axis 22 is offset at a slight angle relative to the axis 88 of the crank 30. More specifically, the pivot axis 22 is angled relative to a transverse direction of the bicycle 10 such that the rear wheel 16 lies within a central longitudinal plane of the bicycle 10 in the erect condition and the rear wheel 16 lies outside and substantially parallel to the central longitudinal plane when in the folded condition. This is achieved by virtue of the pivot axis 22 being angled at between 1.5 and 2.5 degrees relative to the transverse direction of the bicycle 10 such that the rear wheel 16 swings out from the central longitudinal plane of the bicycle when the rear wheel 16 is pivoted from the erect condition to the folded condition.

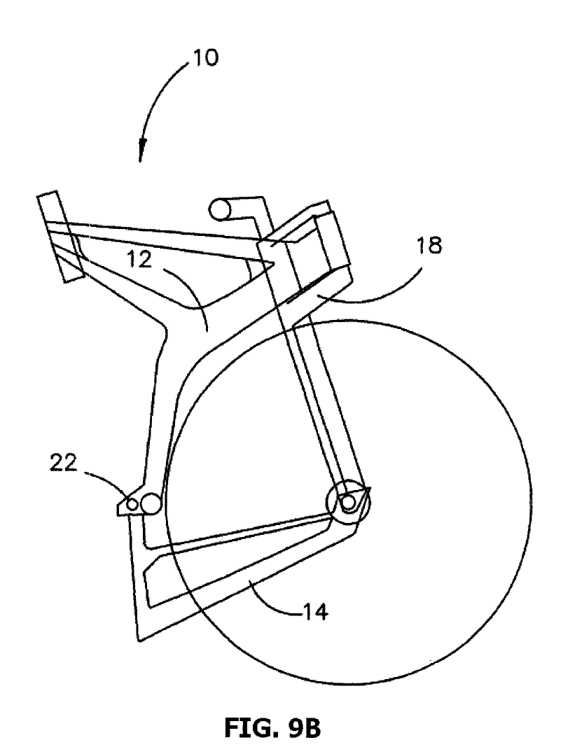

FIGS. 9a and 9b show an alternative example of a folding bicycle 10 in which the pivot axis 22 is slightly rearward of the axis 88 of the crank. FIGS. 9a and 9b illustrate the front wheel 20 being pivoted relative to the main frame 12 about the steering axis 26 to the reversed configuration (shown in broken lines in FIG. 9a and solid lines in FIG. 9b).

The front arm 18 comprises a pivot body 90, a down member 92, and an extension portion 94 between the pivot body 90 and the down member 92. In the erect condition, the extension portion 94 positions the down member 92 forward of the steering axis 26 and in the folded condition, the extension portion 94 positions the down member 92 rearward of the steering axis 26. The pivot body 90 may house the nylon bearings 78, or bearings made of other material. When the front arm 18 is moved to the reversed configuration, the extension portion 94 is housed within a recess 96 (see FIG. 1) formed in a side of the main frame 12, and the down member 92 extends outwardly and downward from the recess 96.

While various embodiments of the present invention have been described above, it should be understood that they have been presented by way of example only, and not by way of limitation. It will be apparent to a person skilled in the relevant art that various changes in form and detail can be made therein without departing from the spirit and scope of the invention. Thus, the present invention should not be limited by any of the above described exemplary embodiments.

The reference in this specification to any prior publication (or information derived from it), or to any matter which is known, is not, and should not be taken as an acknowledgment or admission or any form of suggestion that that prior publication (or information derived from it) or known matter forms part of the common general knowledge in the field of endeavour to which this specification relates.

Throughout this specification and the claims which follow, unless the context requires otherwise, the word “comprise”, and variations such as “comprises” and “comprising”, will be understood to imply the inclusion of a stated integer or step or group of integers or steps but not the exclusion of any other integer or step or group of integers or steps.

1. A folding bicycle being foldable between an erect condition for riding and a compact folded condition, including a main frame, a rear frame coupling a rear wheel of the bicycle to the main frame, and a front arm coupling a front wheel of the bicycle to the main frame, wherein in folding the bicycle from the erect condition to the folded condition the rear frame is folded relative to the main frame about a pivot axis substantially transverse to the bicycle to overlap the front and rear wheels.

2. A folding bicycle as claimed in claim 1, wherein in the folded condition the front and rear wheels are adjacent.

3. A folding bicycle as claimed in claim 2, wherein in the folded condition a hub of the front wheel is adjacent a hub of the rear wheel.

4. A folding bicycle as claimed in claim 3, wherein the front and rear hubs are single sided hubs and in the folded condition a free end of the front wheel hub is adjacent a free end of the rear wheel hub.

5. A folding bicycle as claimed in claim 4, wherein a disc of a front disc brake is mounted to the front wheel and a disc brake calliper of the front disc brake is mounted to the front arm.

6. A folding bicycle as claimed in claim 4, wherein a disc of a rear disc brake is mounted to the rear wheel and a disc brake calliper of the rear disc brake is mounted to the rear frame.

7. A folding bicycle as claimed in claim 1, wherein in the erect condition weight of a rider on a saddle of the bicycle biases the rear frame toward the erect condition.

8. A folding bicycle as claimed in claim 7, wherein the rear frame forms a triangle and one side of the triangle abuts a rear face of the main frame when in the erect condition.

9. A folding bicycle as claimed in claim 7, wherein in the erect condition a member of the rear frame is seated within a sleeve of the main frame.

10. A folding bicycle as claimed in claim 1, wherein the pivot axis is substantially in line with an axis about which a drive crank rotates.

11. A folding bicycle as claimed in claim 1, wherein the rear frame pivots about a bottom bracket of the bicycle.

12. A folding bicycle as claimed in claim 1, wherein the pivot axis is angled relative to a transverse direction of the bicycle such that the rear wheel lies within a central longitudinal plane of the bicycle in the erect condition and the rear wheel lies outside and substantially parallel to the central longitudinal plane when in the folded condition.

13. A folding bicycle as claimed in claim 12, wherein the pivot axis is angled at between 1 and 5 degrees relative to the transverse direction of the bicycle.

14. A folding bicycle as claimed in claim 13, wherein the pivot axis is angled at between 1.5 and 2.5 degrees relative to the transverse direction of the bicycle.

15. A folding bicycle as claimed in claim 1, wherein in folding the bicycle from the erect condition to the folded condition the front wheel is pivoted relative to the main frame about a steering axis to a reversed configuration.

16. A folding bicycle as claimed in claim 15, wherein the front arm comprises a pivot body, a down member, and an extension portion between the pivot body and the down member, and wherein in the erect condition the extension portion positions the down member forward of the steering axis and in the folded condition the extension portion positions the down member rearward of the steering axis.

17. A folding bicycle as claimed in claim 16, wherein the pivot body comprises a bearing housing.

18. A folding bicycle as claimed in claim 15, wherein in the reversed configuration the extension portion is housed within a recess formed in a side of the main frame, and the down member extends outwardly and downward from the recess.

19. A folding bicycle as claimed in claim 15, wherein the front arm and rear frame are folded simultaneously relative to the main frame.

20. A folding bicycle as claimed in claim 1, wherein the front arm has a handlebar fixed thereto for steering the bicycle, the handlebar including a central portion and a handle portion at each end pivotally attached to the central portion at pivot locations, wherein each handle portion is locked in line with the central portion by way of a respective locking ring which is biased to a locked condition over the pivot locations, and the handle portions are able to be folded relative to the central portion by sliding the locking rings away from the pivot locations.

21. A folding bicycle as claimed in claim 1, wherein the front and rear wheels are 26 or 27 inches in diameter.

22. A folding bicycle as claimed in claim 21, wherein the front and rear wheels are of size 700C.
